(19) United States
(12) Patent Application Publication
(10) Pub. No.: US 2012/0207508 A1
(43) Pub. Date: Aug. 16, 2012

(54) Image Forming Apparatus and Image Forming Method

(75) Inventors: Kazuhiro NISHIYAMA, Shiojiri-shi (JP); Kazuma MIYAZAWA, Shiojiri-shi (JP); Yoshitomo HIRATA, Shiojiri-shi (JP); Tsutomu SASAKI, Matsumoto-shi (JP); Naoyuki OKUMURA, Shimosuwa-machi (JP); Yuichiro TSUKADA, Shiojiri-shi (JP)

(73) Assignee: SEIKO EPSON CORPORATION, Tokyo (JP)

(21) Appl. No.: 13/365,036

(22) Filed: Feb. 2, 2012

(30) Foreign Application Priority Data
Feb. 15, 2011 (JP) 2011-029499
Mar. 16, 2011 (JP) 2011-057574

(51) Int. Cl. G03G 21/00; G03G 15/02; G03G 15/10

(52) U.S. Cl. 399/99; 399/237; 399/168

(57) ABSTRACT

The image forming apparatus includes an image carrier drum on which a latent image is formed; a development unit which includes a development roller coming into contact with the image carrier drum on an upward side of a virtual horizontal plane, which is perpendicular to a virtual vertical plane passing through a rotation center of the image carrier drum, in a vertical direction and developing the latent image formed on the image carrier drum with a liquid developer containing toner and a carrier liquid; a squeeze unit which comes into contact with the image developed by the development roller on the upward side of the virtual horizontal plane in the vertical direction and includes a squeeze roller squeezing the image; and a transfer unit which transfers the image squeezed by the squeeze roller to a transfer member on a downward side of the virtual horizontal plane in the vertical direction.

### BACKGROUND

1. Technical Field

The present invention relates to an image forming apparatus and an image forming method capable of developing and forming an image with a liquid developer containing a carrier liquid and toner.

2. Related Art

Hitherto, liquid development type image forming apparatuses, which forms an electrostatic latent image on an image carrier drum such as a photosensitive drum, developing the electrostatic latent image with a liquid developer in which toner is dispersed in a carrier liquid to form a toner image, and transferring the toner image to a sheet through an intermediate transfer member to form a predetermined image, have been put into practical use. Further, in the image forming apparatuses, a squeeze unit such as a squeeze roller is used to remove a surplus developer or fogging toner contained in the surplus carrier liquid from the toner image formed on the image carrier drum. For example, JP-A-2004-271804 discloses an apparatus in which a development device, a squeeze device, and an intermediate transfer drum are disposed so as to be very close to each other in a rotation direction of an image carrier drum.

In the known apparatuses, the following problem may arise since the development device, the squeeze device, and the intermediate transfer drum are disposed so as to be very close to each other. That is, the development device has to include a development roller coming into contact with the image carrier drum, and constituent elements such as a supply member supplying a liquid developer to the development roller and a cleaning member have to be disposed inside the development device. Further, the squeeze device has to include a squeeze roller coming into contact with the image carrier drum, and constituent elements such as a cleaning member configured to clean and remove the liquid developer from the squeeze roller has to be disposed in the squeeze device. Accordingly, it is necessary to dispose the development device, the squeeze device, and the intermediate transfer drum very closely and ensure a space for disposing the above-described constituent elements. For this reason, since it is necessary to increase the size of the image carrier drum or decrease the size and diameter of the development roller or the squeeze roller, the cost may increase or the freedom of design may deteriorate.

### SUMMARY

An advantage of some aspects of the invention is that it provides an image forming apparatus and an image forming method capable of squeezing a toner image obtained by developing a latent image carried by an image carrier drum with a liquid developer, and then transferring the toner image to a transfer member at low cost and in the high freedom of design.

According to a first aspect of the invention, there is provided an image forming apparatus including: an image carrier drum on which a latent image is formed; a development unit which includes a development roller coming into contact with the image carrier drum on an upward side of a virtual horizontal plane, which is perpendicular to a virtual vertical plane passing through a rotation center of the image carrier drum, in a vertical direction and developing the latent image formed on the image carrier drum with a liquid developer containing toner and a carrier liquid; a squeeze unit which comes into contact with the image developed by the development roller on the upward side of the virtual horizontal plane in the vertical direction and includes a squeeze roller squeezing the image; and a transfer unit which transfers the image squeezed by the squeeze roller to a transfer member on a downward side of the virtual horizontal plane in the vertical direction.

According to a second aspect of the invention, there is provided an image forming method including: forming a latent image on an image carrier drum; developing the latent image with a liquid developer containing a carrier liquid and toner carried on a development roller which is disposed on an upward side of a virtual horizontal plane, which is perpendicular to a virtual vertical plane passing through a rotation center of the image carrier drum, in a vertical direction; bringing a squeeze roller disposed on the upward side of the virtual horizontal plane in the vertical direction into contact with the image developed by the development roller and squeezing the image; and transferring the image squeezed by the squeeze roller to a transfer member on a downward side of the virtual horizontal plane in the vertical direction.

According to the aspects of the invention (the image forming apparatus and the image forming method), the development roller and the squeeze roller are disposed on the upward side of the virtual horizontal plane, which is perpendicular to the virtual vertical plane passing through the rotation center of the image carrier drum, in a vertical direction. The image obtained by developing the latent image carried on the image carrier drum with the liquid developer is squeezed by the squeeze roller. The development process and the squeeze process are performed on the upper side of the virtual horizontal plane in the vertical direction. Thus, the transfer unit transfers the toner image to the transfer member on the downward side of the virtual horizontal plane in the vertical direction. Accordingly, there is lesser space restriction, which occurs in an apparatus according to the related art, when the development unit or the squeeze unit is disposed. Moreover, the development unit, the squeeze unit, and the transfer unit can be disposed at low cost and in high freedom of design.

### BRIEF DESCRIPTION OF THE DRAWINGS

The invention will be described with reference to the accompanying drawings, wherein like numbers reference like elements.

FIG. 1 is a diagram illustrating an image forming apparatus according to a first embodiment of the invention.

FIG. 2 is a diagram illustrating a disposition relationship between a photosensitive drum and a blanket roller.

FIG. 3 is a block diagram illustrating a part of the electric configuration of the image forming apparatus shown in FIG. 1.

FIG. 4 is a diagram illustrating a surface potential relationship between a development position and a squeeze position according to the first embodiment.

FIG. 5 is a diagram illustrating an image forming apparatus according to a second embodiment of the invention.

FIG. 6 is a diagram illustrating a surface potential relationship between a development position and a squeeze position according to the second embodiment.

FIG. 7 is a diagram illustrating an image forming apparatus according to a third embodiment of the invention.

FIG. 8 is a perspective view illustrating the configuration near a transfer unit.

FIGS. 9A and 9B are diagrams illustrating a photosensitive cleaning section including a developer recovery mechanism.

FIG. 10 is a perspective view illustrating the configuration of a developer receiving member.

FIG. 11 is a diagram illustrating an image forming apparatus according to a fourth embodiment of the invention.

FIG. 12 is a diagram illustrating an image forming apparatus according to a fifth embodiment of the invention.

FIGS. 13A and 13B are diagrams illustrating an image forming apparatus according to a sixth embodiment of the invention.

### DESCRIPTION OF EXEMPLARY EMBODIMENTS

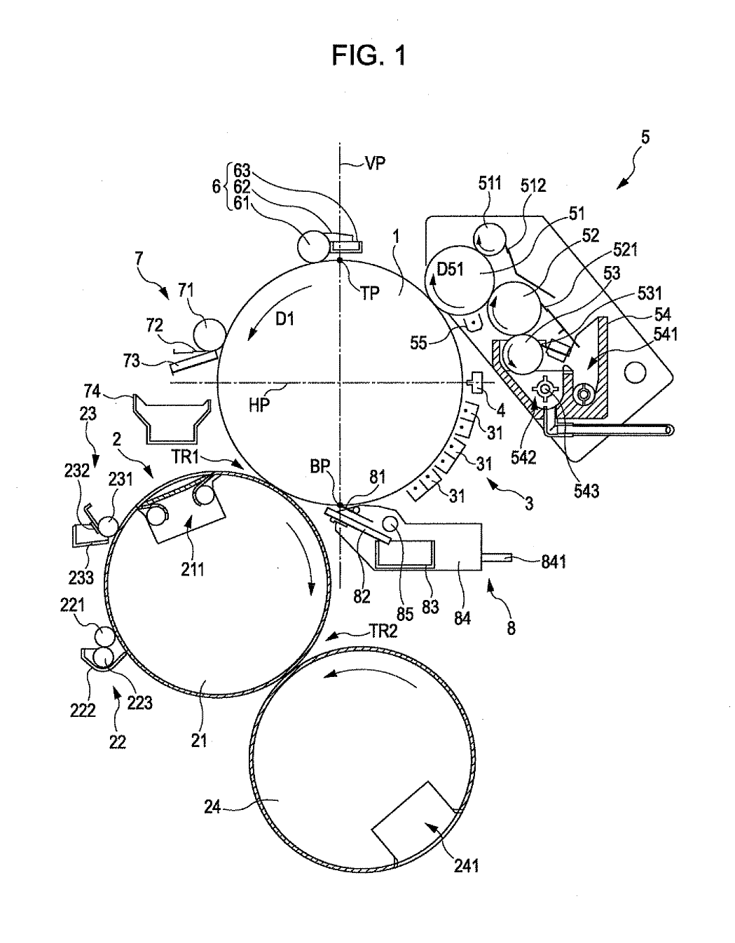

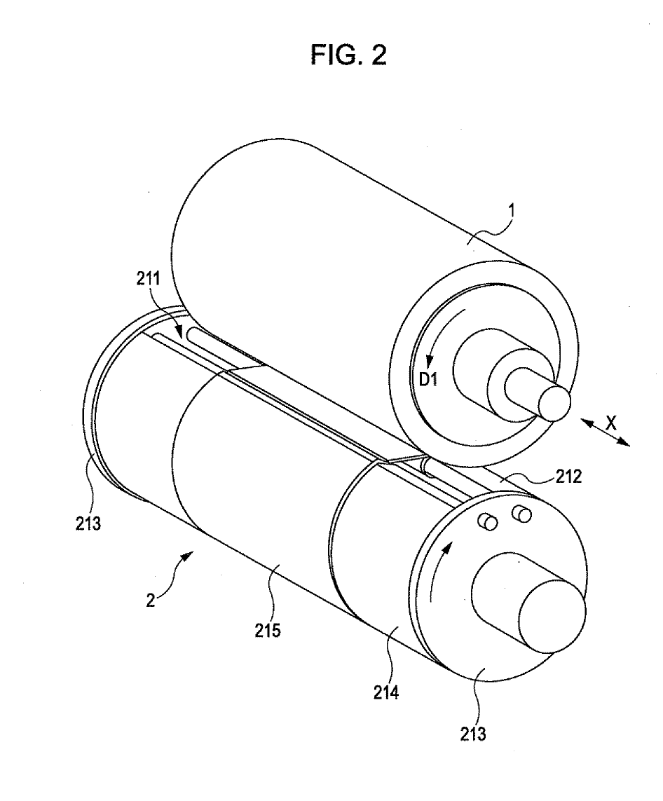

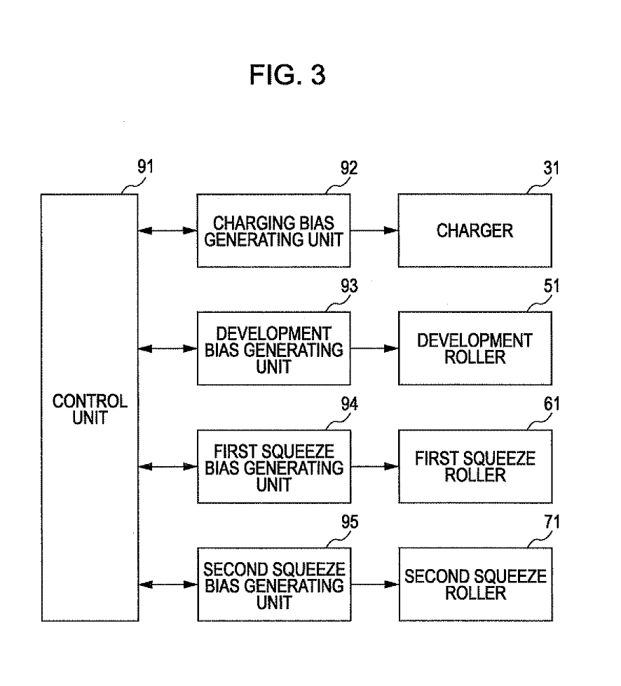

Hereinafter, the first and second aspects of the invention will be described. FIG. 1 is a diagram illustrating an image forming apparatus according to a first embodiment of the invention. FIG. 2 is a diagram illustrating a disposition relationship between a photosensitive drum and a blanket roller. FIG. 3 is a block diagram illustrating a part of the electric configuration of the image forming apparatus shown in FIG. 1. The image forming apparatus has a so-called base transfer structure, in which an image carried on a photosensitive drum 1 is transferred to a blanket roller 21 of a primary transfer unit 2 and the image transferred to the blanket roller 21 is further transferred to a transfer sheet, on a downward side of a virtual horizontal plane HP, which passes through the rotation center of the photosensitive drum 1, in a vertical direction. As described later, the image forming apparatus in FIG. 1 forms a monochromatic toner image and transfer the monochromatic toner image to a transfer sheet. The plurality of image forming apparatuses, for example, four image forming apparatuses can be arranged to form a color printing system. Of course, the single image forming apparatus in FIG. 1 may be configured as a monochromatic image forming apparatus.

In the image forming apparatus, the photosensitive drum 1 has a photosensitive layer made of a photosensitive material, such as an amorphous silicon photosensitive member. In addition, the photosensitive drum 1 is disposed so that the rotation shaft is parallel or substantially parallel to a main scanning direction X (a direction perpendicular to the sheet surface of FIG. 1). The photosensitive drum 1 is rotatably driven at a predetermined speed in a direction of an arrow D1 in FIG. 1.

A charging unit 3 that charges the surface of the photosensitive drum 1, an exposure unit 4 that forms an electrostatic latent image by exposing the surface of the photosensitive drum 1 in accordance with an image signal, a development unit 5 that develops the electrostatic latent image as a toner image, a first squeeze unit 6, a second squeeze unit 7, the blanket roller 21 of the primary transfer unit 2, and a photosensitive cleaning section 8 that cleans the surface of the photosensitive drum 1 after primary transfer are arranged around the photosensitive drum 1 in this order in the rotation direction D1 (counterclockwise rotation in FIG. 1) of the photosensitive drum 1.

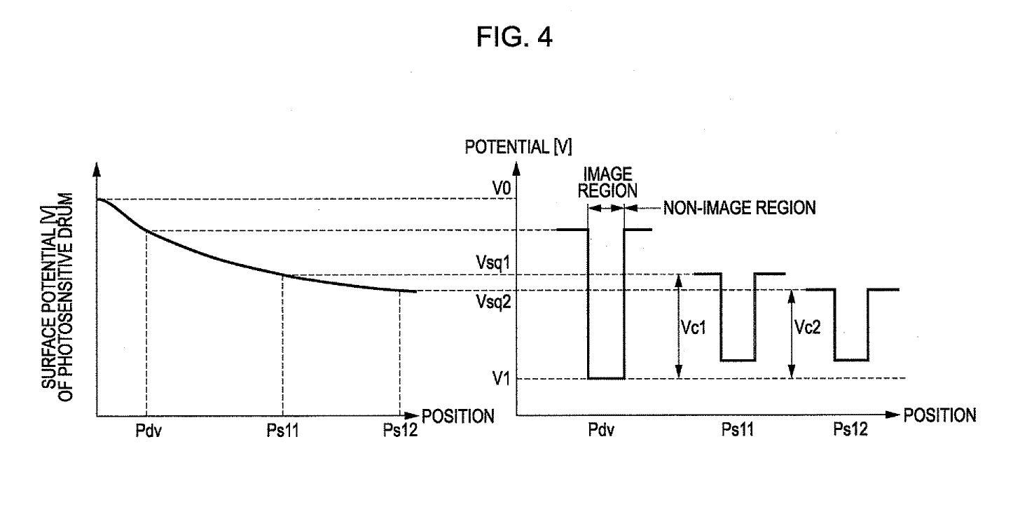

The charging unit 3 includes six chargers 31. The charging unit 3 is disposed on the right side with respect to a virtual vertical plane VP passing through the rotation center of the photosensitive drum 1 and on the downward side of the virtual horizontal plane HP, which passes through the rotation center of the photosensitive drum 1, in the vertical direction on the sheet surface of FIG. 1. The six chargers 31 do not come into contact with the surface of the photosensitive drum 1 and are disposed in the rotation direction D1 of the photosensitive drum 1. When a charging bias generating unit 92 applies a charging bias to the chargers 31 in response to a charging instruction from a control unit 91 that controls the entire apparatus, the surface of the photosensitive drum 1 is charged with a predetermined surface potential V0 (see FIG. 4). For example, a general corona charger according to the related art can be used as the charger 31. When a scorotron charger is used in the corona charger, a wire current flows in a charge wire of the scorotron charger and a direct-current (DC) grid charging bias is applied to a grid. When the photosensitive drum 1 is charged through corona charging by the chargers 31, the potential of the surface of the photosensitive drum 1 is set to a substantially uniform potential.

The exposure unit 4 is disposed on the right side of the virtual vertical plane VP on the sheet surface of FIG. 1 and on the virtual horizontal plane HP. The exposure unit 4 exposures an image region in the surface of the photosensitive drum 1 using a light beam in response to an image signal given from an external apparatus and varies the surface potential of the image region to a potential V1. In this way, an electrostatic latent image corresponding to the image signal is formed on the surface of the photosensitive drum 1 (see FIG. 4). In this embodiment, a line head which has light-emitting elements arranged in the main scanning direction (a direction perpendicular to the sheet surface of FIG. 1) is used as the exposure unit 4. However, for example, a unit that scans a light beam with a semiconductor laser by a polygon mirror may be used. In this embodiment, the exposure unit 4 is disposed on the virtual horizontal plane HP, but the disposition position of the exposure unit 4 is not limited thereto. The exposure unit 4 may be disposed on the upward side or the downward side of the virtual horizontal plane HP in the vertical direction.

FIG. 4 is a diagram illustrating a relationship between the surface potentials at the development position and the squeeze position according to the first embodiment. The left graph in the drawing shows the attenuation characteristics of the surface potential of the photosensitive drum 1 charged with a surface potential V0. The right graph in the drawing shows the surface potentials of the photosensitive drum 1 at a development position Pdv at which the development roller 51 comes into contact with the surface of the photosensitive drum 1, at a first squeeze position Ps11 at which a first squeeze roller 61 of the first squeeze unit 6 comes into contact with the surface of the photosensitive drum 1, and a second squeeze position Ps12 at which a second squeeze roller 71 of the second squeeze unit 7 comes into contact with the surface of the photosensitive drum 1. As shown in the drawing, the surface potential of a non-image region of the photosensitive drum 1 attenuates from the charging position.

A liquid developer is applied to the electrostatic latent image formed in this way from the development unit 5, so that the electrostatic latent image is developed with toner. In this embodiment, a liquid developer is used in which colored resin particles are disposed as toner particles at a ratio by weight of about 25% in a carrier liquid having an insulation liquid as a main component. Therefore, the toner particles have charges which can be electrophoretic in an electric field. The concentration of the developer is not limited to 25%, but may be in the range of 10% to 30%. For example, Isopar (trademark of Exxon Corporation), silicon oil, or normal paraffin oil is used as the carrier liquid. The electric resistance value is 1010 Ω·cm or more and is preferably 1012 Ω·cm or more. This is because when the resistance is low, a surplus current flows during the electrophoresis of the toner particles and a necessary electric field may not be held. The viscosity of the liquid developer made in this way depends on the a resin or dispersant charge controlling agent of the toner particles. The liquid developer having the viscosity of 50 [Pa·s] to 500 [Pa·s] can be used. In this embodiment, the liquid developer with the viscosity of 400 [Pa·s] is used.

The development unit 5 of the image forming apparatus is disposed on the right side of the virtual vertical plane VP on the sheet surface of FIG. 1 and on the upward side of the charging unit 3 in the vertical direction. The development unit 5 includes the development roller 51, an intermediate application roller 52, an anilox roller 53, a developer container 54 storing the liquid developer, and a toner compression corona generator 55 executing a charging and compression operations on the liquid developer, as the main constituent elements. Among the main constituent elements, the development roller 51 is a cylindrical member in which an elastic layer made of polyurethane rubber, silicon rubber, NBR, or the like is formed on the outer circumference of an inner core made of a metal material such as iron and PFA tube or resin is coated on a development roller surface layer which is the further outer circumference. The development roller 51 is connected to a development motor (not shown) and is rotatably driven in a clockwise rotation direction D51 on the sheet surface of FIG. 1 to be rotated with the photosensitive drum 1. The development roller 51 is electrically connected to a development bias generating unit 93, and thus is configured so that a development bias is applied at an appropriate timing.

The intermediate application roller 52 and the anilox roller 53 are disposed on the downward side of the development roller 51 in the vertical direction to supply the liquid developer to the development roller 51. The liquid developer is supplied from the anilox roller 53 to the development roller 51 via the intermediate application roller 52. Among the rollers, the intermediate application roller 52 has a configuration in which an elastic layer is formed on the outer circumference of the inner core made of metal, like the development roller 51. The anilox roller 53 is a roller in which a concave pattern such as minutely and uniformly carved spiral grooves is formed on the surface so that the liquid developer is easily carried. Of course, like the development roller 51 or the intermediate application roller 52, the anilox roller 53 may have a configuration in which a rubber layer made of urethane or NBR is wound around a metal core or a PFA tube is coated on the metal core. The intermediate application roller 52 and the anilox roller 53 are connected to the development motor and are rotated clockwise and counterclockwise, respectively, on the sheet surface of FIG. 1. Accordingly, the intermediate application roller 52 is rotated in a counter direction with respect to the development roller 51 and the anilox roller 53 is rotated in a with-direction with respect to the intermediate application roller 52. In this embodiment, the liquid developer is pumped from a storage section 542 of the developer container 54 by a so-called three-roller configuration and is supplied to the development roller 51. Therefore, since the liquid developer is sufficiently kneaded by passing through a plurality of nip portions, a film of the uniform liquid developer can be formed in the development roller 51. Of course, the invention is not limited thereto, but the liquid developer may be applied directly from the anilox roller 53 to the development roller 51 (two-roller configuration).

A cleaning roller 511 comes into contact with the development roller 51 and a roller cleaning blade 512 comes into contact with the cleaning roller 511, so that the development roller 51 can be cleaned. That is, the cleaning roller 511 is rotated clockwise on the sheet surface of FIG. 1 while coming into contact with the surface of the development roller 51 on the downstream side of a development position, at which the surface of the development roller 51 comes into contact with the photosensitive drum 1 to form a development nip portion, in the development roller rotation direction D51. Accordingly, the cleaning roller 511 is rotated in the counter direction with respect to the development roller 51 and removes the liquid developer remaining on the development roller 51 without contribution to the development. The roller cleaning blade 512 comes into contact with the surface of the cleaning roller 511, and thus removes the liquid developer by scraping and dropping the liquid developer toward the downward side of the roller cleaning blade 512 in the vertical direction. A cleaning blade 521 comes into contact with the intermediate application roller 52, and thus removes the liquid developer remaining on the intermediate application roller 52 from the surface of the intermediate application roller 52 without contribution to the development by scraping and dropping the liquid developer toward the downward side of the roller cleaning blade 521 in the vertical direction. The liquid developer scraped and dropped by the cleaning blades 512 and 521 is guided and recovered to a recovery section 541 of the developer container 54 disposed on the downward side of the development roller 51 in the vertical direction. In this embodiment, the cleaning roller 511 and the roller cleaning blade 512 form a “cleaning section” of the invention. The configuration of the cleaning section is not limited thereto. For example, the cleaning blade 512 may come into direct contact with the development roller 51 so as to perform the cleaning process.

On the other hand, a regulation member 531 comes into contact with the anilox roller 53. A member made of a metal material or configured such that the surface is coated with an elastic body so as to have elasticity can be used as the regulation member 531. The regulation member 531 according to this embodiment includes a rubber portion formed of a urethane rubber coming into contact with the surface of the anilox roller 53 and a metal plate holding the rubber portion. The regulation member 531 has a function of regulating and adjusting the film thickness or amount of the liquid developer carried and transported by the anilox roller 53 and adjusting the amount of liquid developer to be supplied to the development roller 51. The liquid developer scraped by the regulation member 531 is returned to the storage section 542 of the developer container 54. Further, an agitating member 543 is disposed in the storage section 542 and is rotated by a motor (not shown) so that the liquid developer is agitated within the storage section 542.

The development roller 51 to which the liquid developer is supplied is rotated to be moved in a direction opposite to the surface of the intermediate application roller 52 and is rotated to be moved in the same direction as the surface of the photosensitive drum 1. Further, in order to form a toner image, the development roller 51 has to be rotated with the photosensitive drum 1 so that the surface of the development roller 51 is moved in the same direction as that of the surface of the photosensitive drum 1. However, the surface of the development roller 51 may be moved in the opposite direction or the same direction with respect to the intermediate application roller 52.

The toner compression corona generator 55 is disposed in the rotation direction of the development roller 51. More specifically, the toner compression corona generator 55 is disposed on the upstream side of the development position in the development roller rotation direction D51. The toner compression corona generator 55 is an electric field applying unit that increases the bias of the surface of the development roller 51. The toner of the liquid development transported by the development roller 51 is charged and compressed when the electric field is applied at a position close to the toner compression corona generator 55. In the charging and the compressing of the toner, a compaction roller that performs charging in a contact manner may be used instead of the corona discharging by the application of the electric field.

The development unit 5 having the above-described configuration is connected to a development separation and contact mechanism (not shown). When a control instruction is transmitted from a controller (not shown) to the development separation and contact mechanism, the development unit 5 can reciprocate between the development position (a position indicated by a solid line in FIG. 1), at which a latent image is developed on the photosensitive drum 1, and a retreat position (not shown) distant from the photosensitive drum 1. Accordingly, while the development unit 5 is moved to the retreat position and is positioned, the supply of new liquid developer to the photosensitive drum 1 is stopped.

The first squeeze unit 6 is disposed on the downstream side of the development position in the rotation direction D1 of the photosensitive drum 1 and the second squeeze unit 7 is disposed on the downstream side of the first squeeze unit 6. In this embodiment, both a squeeze roller 61 of the first squeeze unit 6 and a squeeze roller 71 of the second squeeze unit 7 are disposed at positions on the left side of the virtual vertical plane VP on the sheet surface of FIG. 1 and above the virtual horizontal plane HP in the vertical direction.

The first squeeze unit 6 includes the squeeze roller 61 urged in the direction of the photosensitive drum 1 by a spring (not shown). That is, the first squeeze position Ps11 at which the squeeze roller 61 comes into contact with the photosensitive drum 1 is lower than a top position TP intersecting the virtual vertical plane VP upward in the vertical direction of the photosensitive drum 1 and is located at the opposite side (the left side in FIG. 1) to the side (the right side of FIG. 1) on which the development roller 51 is disposed with reference to the virtual vertical plane VP. At the first squeeze position, the squeeze roller 61 removes the surplus developer of the toner image by being rotatably driven by a motor (not shown) while coming into contact with the toner image formed on the surface of the photosensitive drum 1. In this embodiment, since a first squeeze bias generating unit 94 is electrically connected to the squeeze roller 61 to improve a squeeze efficiency, a first squeeze bias is configured to be applied at an appropriate timing. A cleaning blade 62 comes into contact with the surface of the squeeze roller 61 and scrapes the liquid developer attached on the roller surface. The liquid developer scraped in this way is recovered to a recovery member 63.

The second squeeze unit 7 removes the surplus carrier liquid or fogging toner of the toner image at a second squeeze position Ps12 on the downstream side of the first squeeze position in the rotation direction D1 of the photosensitive drum 1, while the squeeze roller 71 is rotated while coming into contact with the toner image formed on the surface of the photosensitive drum 1. In this embodiment, in order to improve the squeeze efficiency, a second squeeze bias generating unit 95 is electrically connected to the squeeze roller 71 like the first squeeze unit 6. Therefore, the second squeeze bias is applied at an appropriate timing. Further, a cleaning blade 72 comes into contact with the surface of the squeeze roller 71 and scrapes the liquid developer attached on the roller surface. The scraped liquid developer is guided in a direction distant from the photosensitive drum 1 by a guide member 73 and is recovered to the recovery member 74 disposed on the downward side of the guide member 73 in the vertical direction. In this embodiment, the two squeeze units 6 and 7 are provided, but the number of squeeze units or the disposition of the squeeze units are not limited thereto. For example, one squeeze unit may be disposed.

The toner image corresponding to the image signal given from the outside of the apparatus is formed on the photosensitive drum 1 passing through the first squeeze unit 6 and the second squeeze unit 7 and is transferred to the blanket roller 21 at a primary transfer position TR1. The transfer unit 2 including the blanket roller 21 is disposed on the right side with respect to the virtual vertical plane VP on the sheet surface of FIG. 1 and on the downward side of the virtual horizontal plane HP in the vertical direction. The transfer unit 2 includes the blanket roller 21, a carrier application mechanism 22 applying a carrier liquid to the blanket roller 21, and a cleaning mechanism 23 of the blanket roller 21, and a secondary transfer roller 24.

The blanket roller 21 has a cylindrical shape as a whole, as shown in FIG. 2. A concave portion 211 is formed in a part of the outer circumference of the blanket roller 21. The concave portion 211 is formed by notching a part of the outer circumference surface of a cylindrical roller base member 212 in a rotation shaft direction X of the photosensitive drum 1. However, no concave portion 211 is formed on both end portions 213 of the roller base member 212 in the rotation shaft direction X and the end portions 213 function as so-called bearers. That is, when the concave portion 211 of the blanket roller 21 touches the photosensitive drum 1, both ends portions 213 of the roller base member 212 prevent a member disposed inside the concave portion 211 of the blanket roller 21 from coming into contact with a contact member (not shown) mounted on the photosensitive drum 1 and coming into contact with the photosensitive drum 1.

On the outer circumference surface of the roller base member 212, an elastic sheet formed of an elastic material such as rubber or resin is wound around a surface area other than a region corresponding to the inside of the concave portion 211, and an elastic layer 214 is formed by the elastic sheet. Further, a blanket sheet 215 is wound in a central portion in the rotation shaft direction X in the elastic layer 214. Therefore, when the elastic layer 214 formed in the region other than the concave portion 211 in the outer circumference of the blanket roller 21 is located at the position facing the photosensitive drum 1, the elastic layer 214 is pressed tightly by the photosensitive drum 1, so that a primary transfer nip is formed, and thus a toner image carried on the photosensitive drum 1 is transferred to the blanket sheet 215. The position at which the primary transfer nip is formed is the primary transfer position TR1. When the concave portion 211 of the blanket roller 21 faces the photosensitive drum 1, the primary transfer nip temporarily disappears.

In this embodiment, the primary transfer position TR1 is set on the upstream side in the rotation direction D1 of the photosensitive drum 1 with respect to the bottom position of the photosensitive drum 1 in the vertical direction, that is, a position BP intersecting the virtual vertical surface VP on the downward side of the photosensitive drum 1 in the vertical direction. Since the blanket roller 21 is connected to a motor (not shown), the blanket roller 21 is rotatably driven in a clockwise rotation direction D21 on the sheet surface of FIG. 1 to be rotated with the photosensitive drum 1. In this way, the toner image carried on the photosensitive drum 1 is primarily transferred to the blanket sheet 215 of the blanket roller 21 at the primary transfer position TR1.

On the downstream side of the primary transfer position TR1 in the rotation direction D21 of the blanket roller 21, the secondary transfer roller 24 comes into contact with the blanket roller 21 and is rotated with the blanket roller 21 so that a secondary transfer nip is formed. The secondary transfer roller 24 also has a concave portion 241 like the blanket roller 21. A holding portion (not shown) holding a transfer material is formed in the concave portion 241. The configuration and operation of the holding portion can be realized as disclosed in, for example, JP-A-2010-170005. The holding portion holds a front end portion of the transfer sheet being transported by a transport unit (not shown) and feeds the transfer sheet to the secondary transfer position TR2 formed as follows.

As shown in FIG. 1, the circumference surface of the secondary transfer roller 24 other than the concave portion 241 comes into contact with the circumference surface of the blanket roller 21 other than the concave portion 211, so that the secondary transfer nip is formed. The position at which the secondary transfer nip is formed is the secondary transfer position TR2. When the transfer sheet held by the holding portion is fed to the secondary transfer position TR2 and passes through the secondary transfer nip, the toner image transferred to the blanket sheet 215 of the blanket roller 21 is secondarily transferred to the transfer sheet. In this way, the image formed with the above-described liquid developer is printed on the transfer sheet. When the concave portion 241 of the secondary transfer roller 24 is located at the secondary transfer position TR2, the concave portion 211 of the blanket roller 21 is also located at the secondary transfer position TR2, thereby preventing the interference with the holding portion formed in the concave portion 241 of the secondary transfer roller 24.

The carrier application mechanism 22 is disposed on the downstream side of the secondary transfer position TR2 in the rotation direction D21 of the blanket roller 21. The carrier application mechanism 22 applies the carrier liquid to the surface of the blanket roller 21 after the secondary transferring. In order to apply the carrier liquid, the carrier application mechanism 22 includes a carrier application roller 221 rotated with the blanket roller 21, carrier storage member 222 storing the carrier liquid, and a carrier pumping roller 223 pumping the carrier liquid from the carrier storage member 222 and supplying the carrier liquid to the carrier application roller 221.

The cleaning mechanism 23 is disposed on the downstream side of the carrier application mechanism 22 in the rotation direction D21 of the blanket roller 21 and on the upstream side of the primary transfer position TR1. The cleaning mechanism 23 cleans the surface of the blanket roller 21 immediately before the primary transferring. In order to clean the surface of the blanket roller 21, the cleaning mechanism 23 includes a cleaning roller 231 rotated in a counter direction with respect to the blanket roller 21, a cleaning blade 232 coming into contact with the cleaning roller 231 and cleaning the cleaning roller 231, and a recovery member 233 recovering the toner or the carrier liquid scraped by the cleaning blade 232.

The photosensitive cleaning section 8 is disposed on the downstream side of the primary transfer position TR1 in the rotation direction D1 of the photosensitive drum 1 and the upstream side of the charging position. The photosensitive cleaning section 8 includes a cleaning blade 81, a developer receiving member 82 receiving the liquid developer dropping from the bottom position BP of the photosensitive drum 1, a recovery member 83 recovering the developer received by the developer receiving member 82, and a holding member 84 integrally holding the cleaning blade 81, the developer receiving member 82, and the recovery member 83. The holding member 84 is pivoted about a pivot shaft 85.

A spring member (not shown) is connected to the holding member 84 and urges the holding member 84 counterclockwise on the sheet surface of FIG. 1 to act on the cleaning blade 81 in a direction in which the cleaning blade 81 is separated from the photosensitive drum 1. On the other hand, an engagement portion 841 protrudes at the end portion of the holding member 84 opposite to the photosensitive drum (on the right side of FIG. 1). Therefore, when a movable piece (not shown) presses the engagement portion 841 by a stress greater than the urging force, the holding member 84 is rotated clockwise on the sheet surface of FIG. 1, so that the cleaning blade 81 is moved toward the photosensitive drum 1 and the front end portion of the cleaning blade 81 comes into contact with the bottom position BP of the photosensitive drum 1. Thus, the liquid developer remaining on the photosensitive drum 1 is cleaned and removed. In this way, the liquid development scraped by the cleaning blade 81 is received by the developer receiving member 82 disposed immediately below the bottom position BP of the photosensitive drum 1, and flows along an inclined surface of the developer receiving member 82 and is dropped and stored inside the recovery member 83.

In the first embodiment, the so-called base transfer structure is used in which the primary transferring process of transferring the toner image to the blanket roller 21 by the primary transfer unit 2 is performed on the downward side of the virtual horizontal surface HP in the vertical direction. Therefore, the toner image is transferred to the upper surface of the transfer sheet and the transfer sheet is transported while the transfer sheet faces upward. Accordingly, since the toner image can be formed stably, the transfer sheet can be transported without touch to the image surface.

When the base transfer structure is used, the development roller 51 performing the development process and the first squeeze roller 61 and the second squeeze roller 71 performing the squeeze process are disposed on the upward side of the virtual horizontal plane HP in the vertical direction. Therefore, there is a lesser restriction when the development unit 5 and the squeeze units 6 and 7, compared to an apparatus according to the related art. Moreover, the development unit 5, the squeeze units 6 and 7, and the primary transfer unit 2 can be disposed at low cost and in high freedom of design.

In the image forming apparatus with the above-described configuration, the liquid developer sometimes drop downward in the vertical direction from the bottom position BP of the photosensitive drum 1 due to the own weight of the liquid developer. However, since the blanket roller 21 of the primary transfer unit 2 is dispose on the left side of the virtual vertical plane VP on the sheet surface of FIG. 1, the liquid developer dropping from the bottom position BP of the photosensitive drum 1 can be reliably prevented from being attached to the blanket roller 21, the image quality can be prevented from deteriorating due to the drooping and attachment of the liquid developer. In this embodiment, the liquid developer dropping downward in the vertical direction from the bottom position BP due to the own weight of the liquid developer is received and recovered by the developer receiving member 82 disposed on the downward side of the bottom position BP in the vertical direction.

The blanket roller 21 is disposed on the left side of the virtual vertical plane VP on the sheet surface of FIG. 1 and the development unit 5 is disposed on the right side of the virtual vertical plane VP on the sheet surface of FIG. 1 and the upper side of the virtual horizontal plane HP in the vertical direction. Therefore, in the first embodiment, since the cleaning process, the charging process, and the exposure process can be performed slightly over about ¼ of the entire circumference surface of the photosensitive drum 1 in the rotation direction D51 of the photosensitive drum 1, the freedom of design of the cleaning unit 8, the charging unit 3, and the exposure unit 4 is improved. Further, in the first embodiment, as shown in FIG. 1, the cleaning blade 81 of the cleaning unit 8 comes into contact with the photosensitive drum 1 at the bottom position BP and the exposure unit 4 is disposed on the virtual horizontal plane HP. Accordingly, since it is possible to ensure a space facing about ¼ of the entire circumference surface of the photosensitive drum 1, that is, a relatively broad space located on the right side of the virtual vertical plane VP on the sheet surface of FIG. 1 and on the downward side of the virtual horizontal plane HP in the vertical direction, the space is used as a disposition space of the six chargers 31 in this embodiment. In this way, the uniformity of the surface potential V0 of the photosensitive drum 1 can be improved by increasing the number of chargers 31. Moreover, the wire deterioration can efficiently be prevented by setting the amount of wire current of each charger 31 to be small.

All of the development unit 5 and the squeeze units 6 and 7 are disposed on the upward side of the virtual horizontal plane HP in the vertical direction. Therefore, as shown in the right drawing of FIG. 4, a latent image contrast Vc1 at the first squeeze position Ps11 and a latent image contract Vc2 at the second squeeze position Ps12 are relatively large and the squeeze process can be satisfactorily performed at the squeeze positions Ps11 and Ps12. As a consequence, an excellent image quality can be obtained.

The squeeze units 6 and 7 are disposed on an opposite side to the development unit 5 with respect to the virtual vertical plane VP. More specifically, the development roller 51 of the development unit 5 is disposed on the right side of the virtual vertical plane VP on the sheet surface of FIG. 1 and the squeeze unit 6 is disposed on the left side (the opposite side to the side on which the photosensitive drum 1 and the development roller 51 come into contact with each other) of the virtual vertical plane VP. Accordingly, the following operation advantages can be obtained. That is, during a printing process, a liquid pool of the liquid developer is formed at the position at which the first squeeze roller 61 and the photosensitive drum 1 come into contact with each other, that is, the first squeeze position Ps11. Since the first squeeze position Ps11 is lower than the top position TP intersecting the virtual vertical plane VP upward the vertical direction of the photosensitive drum 1, it is possible to prevent the development unit 5, the exposure unit 4, and the charging unit 3 from being contaminated since the liquid developer droops to the disposition side of the development roller 51 over the top position TP, thereby forming an image with an excellent quality. The same is applied to the second squeeze unit 7.

The squeeze units 6 and 7 brings the cleaning blades 62 and 72 into contact with the squeeze rollers 61 and 71, respectively, to scrape and recover the liquid developer attached on the roller surfaces. Further, since the recovered liquid developer is reused and the liquid developer can efficiently be used, the running cost can be reduced.

In the development unit 5 according to the first embodiment, as shown in FIG. 1, the development roller 51 comes into contact with the photosensitive drum 1 on the upper side of the virtual horizontal plane HP in the vertical direction. Moreover, the supply of the liquid developer to the development roller 51 and the recovery of the liquid developer from the development roller 51 are performed as follows. That is, the liquid developer stored in the storage section 542 of the developer container 54 disposed on the downward side of the development roller 51 in the vertical direction is pumped by the anilox roller 53 and is supplied to the development roller 51 via the intermediate application roller 52. On the other side, the liquid developer is recovered from the development roller 51 by the cleaning roller 511 and the roller cleaning blade 512, and the recovered liquid developer falls down or drops downward in the vertical direction due to the own weight of the liquid developer and is recovered by the recovery section 541 of the developer container 54. Therefore, it is not necessary to provide a special mechanism or a dedicated transport mechanism such as a pump to transport the liquid developer, and the flow movement of the liquid developer in the development unit 5 can be realized at low cost.

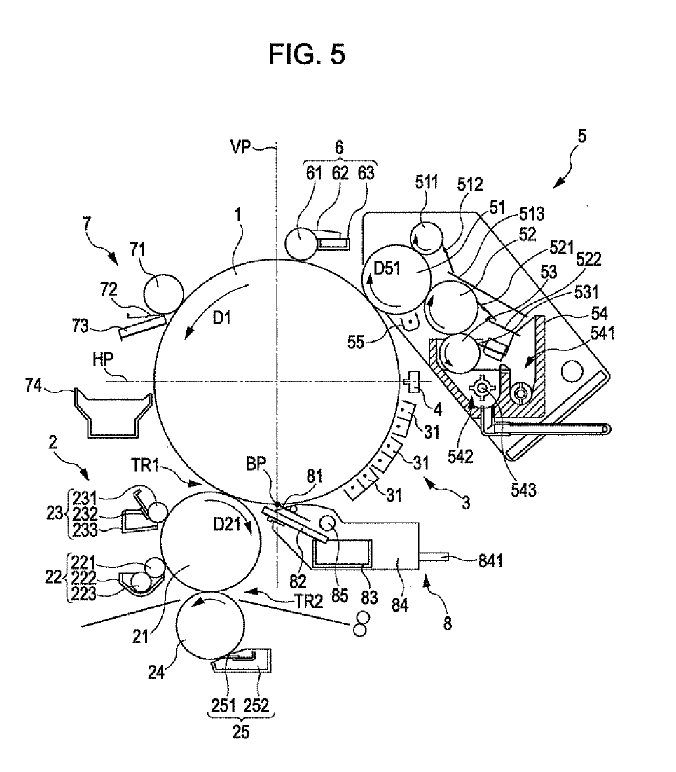

The invention is not limited to the above-described embodiment, but may be modified in various forms without departing from the gist of the invention. For example, in the above-described first embodiment, the blanket roller 21 in which the concave portion 211 is formed in a part of the outer circumference surface is used as a “transfer member” of the invention. However, the invention is applicable to a blanket roller with a different configuration. For example, as shown in FIG. 5, the invention is applicable to an image forming apparatus (second embodiment) in which a blanket roller 21 with a cylindrical drum shape is used as the “transfer member” of the invention.

FIG. 5 is a diagram illustrating an image forming apparatus according to a second embodiment of the invention. The second embodiment is different from the first embodiment in that the blanket roller 21 has a different configuration and the first and second squeeze positions are moved toward the development roller 51. The remaining configuration is basically the same as that of the first embodiment. Therefore, in the following description, the differences will be mainly described. The same reference numerals are given to the same constituent elements and the description thereof will not be repeated.

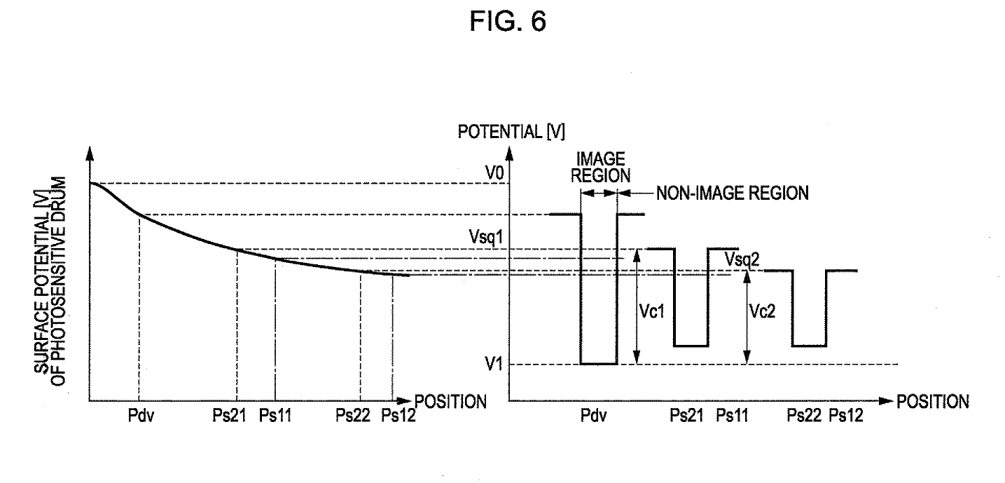

In the second embodiment, a squeeze roller 61 of a first squeeze unit 6 is disposed on the right side (side on which a photosensitive drum 1 and a development roller 51 come into contact with each other) of a virtual vertical plane VP on the sheet surface of FIG. 5 and on the upper side of a virtual horizontal plane HP in the vertical direction. In this way, the squeeze roller 61 comes into contact with the surface of the photosensitive drum 1 at a position Ps21 closer to the development roller 51 compared to the first embodiment. As in the first embodiment, a squeeze roller 71 of a second squeeze unit 7 is disposed on the left side (opposite side to the development roller 51) of the virtual vertical plane VP on the sheet surface of FIG. 5 and on the upper side of the virtual horizontal plane HP in the vertical direction. However, like the squeeze roller 61 of the first squeeze unit 6, the squeeze roller 71 comes into contact with the surface of the photosensitive drum 1 at a position Ps22 closer to the development roller 51 compared to the first embodiment. In order to show the position relationship, FIG. 6 shows not only the squeeze positions Ps21 and Ps22 of the second embodiment but also the squeeze position Ps11 and Ps12 of the first embodiment.

In the second embodiment, the squeeze positions Ps21 and Ps22 are closer to the development position Pdv. Therefore, as shown in the right drawing of FIG. 6, a latent image contrast Vc1 at the first squeeze position Ps21 and a latent image contrast Vc2 at the second squeeze position Ps22 are larger compared to the first embodiment. Accordingly, the squeeze process can be performed further satisfactorily at the squeeze positions Ps21 and Ps22. As a consequence, the more excellent image quality can be obtained.

A toner image corresponding to an image signal given from the outside of the apparatus is formed on the photosensitive drum 1 passing through the first squeeze unit 6 and the second squeeze unit 7 and is transferred to the blanket roller 21 at a primary transfer position TR1. A transfer unit 2 including the blanket roller 21 is disposed on the left side of the virtual vertical plane VP on the sheet surface of FIG. 5 and on the downward side of the virtual horizontal plane HP in the vertical direction. The transfer unit 2 includes the blanket roller 21, a carrier application mechanism 22 applying a carrier liquid to the blanket roller 21, and a cleaning mechanism 23 of the blanket roller 21, a secondary transfer roller 24, and a cleaning mechanism 25 of the secondary transfer roller 24.

The surface of the blanket roller 21 comes into contact with the surface of the photosensitive drum 1 on the upstream side of the photosensitive drum 1 in the rotation direction D1 with respect to the bottom position of the photosensitive drum 1 in the vertical direction, that is, the position BP intersecting the virtual vertical plane VP on the downward side of the photosensitive drum 1 in the vertical direction, so that a primary transfer nip is formed. The position at which the primary transfer nip is formed is the primary transfer position TR1. Since the blanket roller 21 is connected to a motor (not shown), the blanket roller 21 is rotatably driven in the clockwise rotation direction D21 on the sheet surface of FIG. 5 so as to rotated with the photosensitive drum 1. In this way, the toner image carried on the photosensitive drum 1 is primarily transferred to the blanket roller 21 at the primary transfer position TR1.

On the downstream side of the primary transfer position TR1 in the rotation direction D21 of the blanket roller 21, the secondary transfer roller 24 comes into contact with the blanket roller 21 and is rotated with the blanket roller 21, so that a secondary transfer nip is formed. The position at which the secondary transfer nip is formed is a secondary transfer position TR2. Accordingly, when a transfer sheet is fed to the secondary transfer position TR2 by a transport unit (not shown) and passes through the secondary transfer nip, the toner image transferred to the blanket roller 21 is secondarily transferred to the transfer sheet. In order to clean the surface of the secondary transfer roller 24, the cleaning mechanism 25 is disposed on the upstream side of the secondary transfer position TR2 in the rotation direction of the secondary transfer roller 24. The cleaning mechanism 25 includes a cleaning blade 251 coming into contact with the secondary transfer roller 24 and cleaning the secondary transfer roller 24 and a recovery member 252 recovering the toner or the carrier liquid scraped by the cleaning blade 251.

In the second embodiment, as described above, as in the first embodiment, the so-called base transfer structure is used in which the primary transferring process of transferring the toner image to the blanket roller 21 by the primary transfer unit 2 is performed on the downward side of the virtual horizontal surface HP in the vertical direction. The development roller 51 performing the development process and the first squeeze roller 61 and the second squeeze roller 71 performing the squeeze process are disposed on the upward side of the virtual horizontal plane HP in the vertical direction. Accordingly, in the second embodiment, the operation advantages as those of the first embodiment can be obtained.

As described above, the image forming apparatus may include the charging unit that charges the image carrier drum, the exposure unit that exposes the image carrier drum charged by the charging unit, and a bias voltage generating unit that applies a bias voltage to the squeeze roller. The squeeze roller may come into contact with the image carrier drum on the side on which the image carrier drum and the development roller come into contact with each other with respect to the virtual vertical surface.

The squeeze unit may includes the cleaning blade which comes into contact with the squeeze roller and cleans the squeeze roller to recover the liquid developer.

The charging unit may be disposed on the side on which the image carrier drum and the development roller come into contact with each other with respect to the virtual vertical plane and on the downward side of the virtual horizontal plane in the vertical direction. The transfer unit may be disposed on the side opposite to the side on which the image carrier drum and the development roller come into contact with each other with respect to the virtual vertical plane.

The development unit may include a storage section which is disposed on the downward side of the development roller in the vertical direction and stores the liquid developer, a supply member which supplies the liquid developer stored in the storage section to the development roller, a cleaning section which cleans the development roller and recovers the liquid developer, and a recovery section which is disposed on the downward side of the cleaning section in the vertical direction and stores the liquid developer recovered by the cleaning section.

In the above-described embodiment, the first squeeze position at which the first squeeze roller 61 comes into contact with the surface of the photosensitive drum 1 is set to the side of the development roller 51 with respect to the virtual vertical plane VP or the opposite side. However, the first squeeze position may be on the virtual vertical plane VP.

In the above-described embodiment, the exposure unit 4 is disposed on the virtual horizontal plane HP, but the disposition position of the exposure unit 4 is not limited thereto. The exposure unit 4 may be disposed on the upward side or the downward side of the virtual horizontal plane HP in the vertical direction. However, in order to ensure the space where the plurality of chargers 31 are disposed, the exposure unit 4 is preferably disposed on the virtual horizontal plane HP or in the upward side of the virtual horizontal plane HP in the vertical direction.

In the above-described embodiment, the blanket roller 21 is used as the “transfer member” of the invention. However, for example, an intermediate transfer member with a belt shape may be used.

Next, the third and fourth aspects of the invention will be described. Hitherto, liquid development type image forming apparatuses, which forms an electrostatic latent image on a photosensitive member, developing the electrostatic latent image with a liquid developer in which toner is dispersed in a carrier liquid to form a toner image, and transferring the toner image to a sheet through an intermediate transfer member to form a predetermined image, have been put into practical use. For example, in an image forming apparatus disclosed in JP-A-11-174852 (FIG. 1), an intermediate transfer roller is disposed immediately below a photosensitive drum carrying an image. In this way, the bottom position of the photosensitive drum in the vertical direction is set as the primary transfer position and the image on the photosensitive drum is transferred to the intermediate transfer roller. Further, since a pressurizing roller is disposed immediately below the intermediate transfer roller, a print sheet is pressurized and nipped by the intermediate transfer roller and the pressurizing roller, so that the image on the intermediate transfer roller is secondarily transferred to the print sheet. Further, a cleaning blade is disposed near the primary transfer position to remove the toner remaining on the photosensitive drum and clean the photosensitive drum.

In the image forming apparatus having a so-called base transfer structure in which an image developed with the liquid developer is transferred on the downward side of the virtual horizontal plane, which passes through the rotation center of the image carrier member such as a photosensitive drum, in the vertical direction, the following problem may arise. That is, since the liquid developer is used, the liquid developer scraped by the cleaning blade falls down due to the own weight of the liquid developer on the surface of the image carrier member and moves to the bottom position of the image carrier member. Then, some liquid developer droops and is attached to the intermediate transfer roller, and thus the image quality may deteriorate in some cases.

According to several aspects of the invention, there are provided an image forming apparatus and an image forming method in which an image developed with a liquid developer and carried on an image carrier drum is transferred to a transfer unit which is disposed on the downward side of the virtual horizontal plane, which passes through the rotation center of the image carrier drum, in the vertical direction, thereby preventing the image quality from deteriorating since the liquid developer droops from the image carrier drum.

According to a third aspect of the invention, an image forming apparatus includes: an image carrier drum which carries an image developed with a liquid developer; a transfer member which is disposed on the downward side of a virtual horizontal plane, which is perpendicular to a virtual vertical plane passing through the rotation center of the image carrier drum on a first side with respect to the virtual vertical plane passing through the rotation center of the image carrier drum, in the vertical direction and to which the image carried on the image carrier drum is transferred; a cleaning blade which comes into contact with the image carrier drum to which the image is transferred in a position intersecting the virtual vertical plane on the downward side of the image carrier drum in the vertical direction or a second side opposite to the first side with respect to the virtual vertical plane and cleans the image carrier drum; and a developer receiving unit which is disposed on the downward side of the position, which intersects the virtual vertical plane on the downward side of the image carrier drum in the vertical direction, in the vertical direction and stores the liquid developer recovered by the cleaning blade.

According to a fourth aspect of the invention, the image developed with the liquid developer and carried on the image carrier drum is transferred to the transfer member disposed on the first side with respect to the virtual vertical plane passing through the rotation center of the image carrier drum and on the downward side of the virtual horizontal plane in the vertical direction; a cleaning blade is brought into contact with the image carrier drum to which the image is transferred at a position intersecting the virtual vertical plane on a downward side of the image carrier drum in the vertical direction or a second side opposite to the first side with respect to the virtual vertical plane and the image carrier drum is cleaned; and the liquid developer dropping from the image carrier drum is recovered by a developer recovery unit which is disposed on the downward side of the position, which intersects the virtual vertical plane on the downward side of the image carrier drum in the vertical direction, in the vertical direction.

According to the aspects of the invention (the image forming apparatus and the image forming method), the transfer member is disposed on the downward side of the virtual horizontal plane, which passes through the rotation center of the image carrier drum, in the vertical direction, the so-called base transfer structure is embodied. Accordingly, the cleaning blade is configured to come into contact with the image carrier drum at the bottom position of the image carrier drum in the vertical direction or the second side opposite to the first side with respect to the virtual vertical plane and clean the image carrier drum. Therefore, the flow direction of the liquid developer is regulated, and the liquid developer scraped by the cleaning blade flows backward with respect to the rotation direction of the image carrier drum, falls toward in the vertical direction from the bottom position of the image carrier drum due to the own weight of the liquid developer, and is recovered by the developer recovery unit. On the other hand, since the transfer member is disposed on the first side with respect to the virtual vertical plane passing through the rotation center of the image carrier drum, it is possible to reliably prevent the liquid developer drooping from the bottom position of the image carrier drum from being attached to the transfer member.

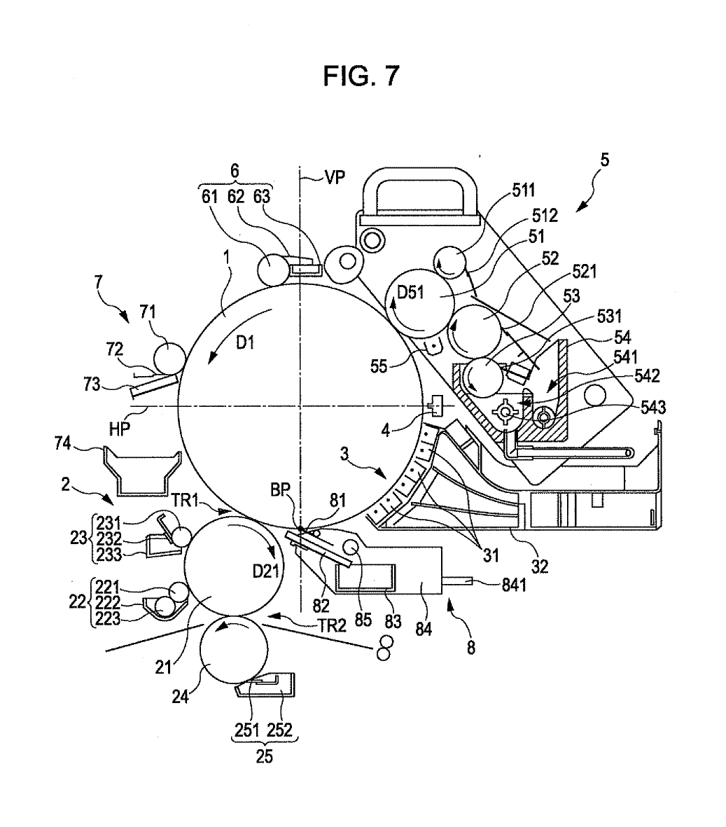

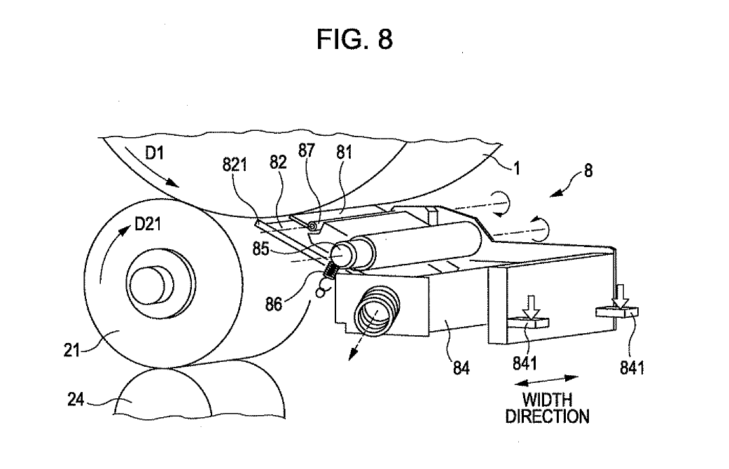

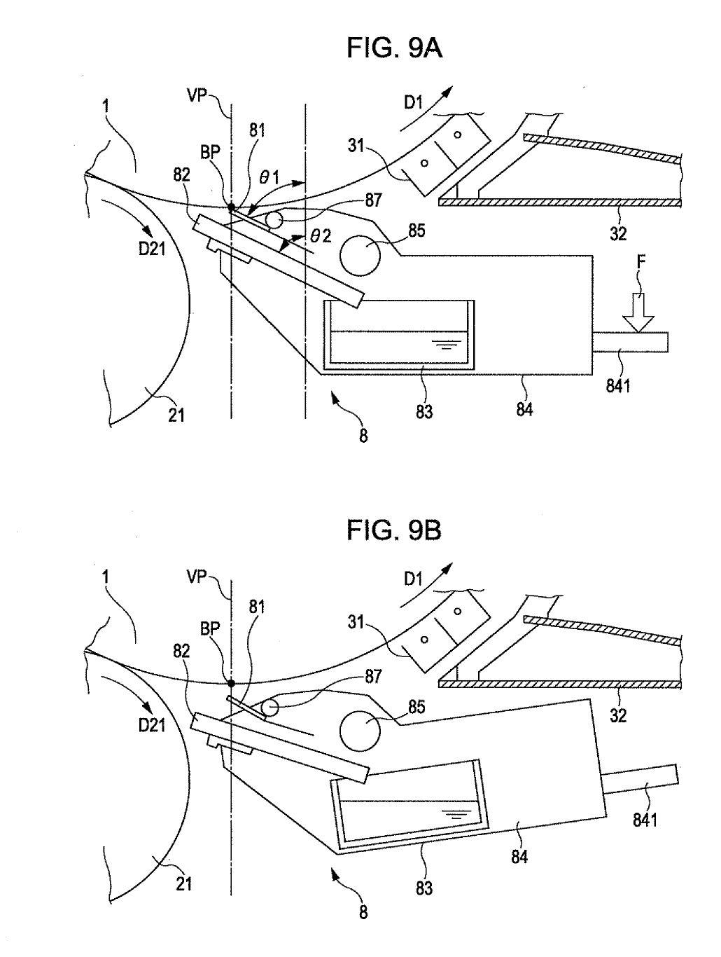

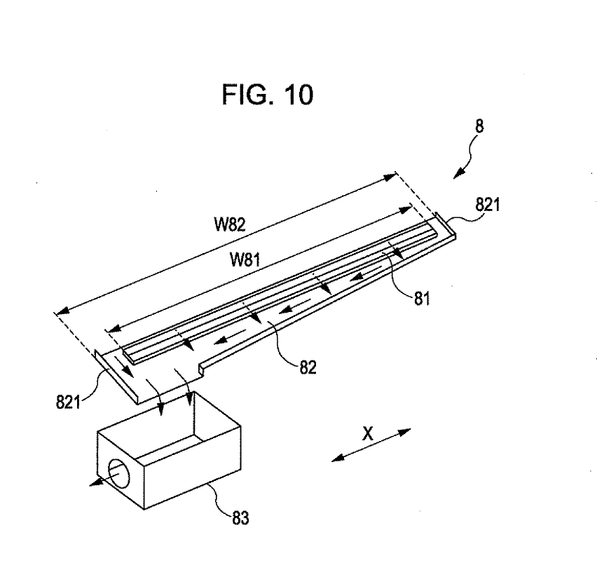

FIG. 7 is a diagram illustrating an image forming apparatus according to a third embodiment of the invention. FIG. 8 is a perspective view illustrating the configuration near a transfer unit. FIGS. 9A and 9B are diagrams illustrating a photosensitive cleaning section including a developer recovery mechanism. FIG. 10 is a perspective view illustrating the configuration of a developer receiving member of the developer recovery mechanism. The image forming apparatus is the same as the image forming apparatus shown in FIG. 5 according to the second embodiment of the invention. The same reference numerals in FIG. 5 are given to the same constituent elements and the description thereof will not be repeated.

A charging unit 3 includes a charger current duct 32. Since the charger current duct 32 has an outside air introduction path (not shown) through which the outside air is introduced toward chargers 31 and a discharging path (not shown) through which the atmosphere generated due to the discharging of the chargers 31 is discharged, the atmosphere is managed by giving a current to the atmosphere under which the charging process is performed.

A spring member 86 is connected to a holding member 84 of the photosensitive cleaning section 8 and urges the holding member 84 counterclockwise on the sheet surface of FIGS. 9A and 9B, to act on the cleaning blade 81 in a direction in which the cleaning blade 81 is separated from the photosensitive drum 1. FIG. 9A shows a state where the cleaning blade 81 comes into contact with the photosensitive drum 1 and FIG. 9B shows a state where the cleaning blade 81 is separated from the photosensitive drum 1. On the other hand, two engagement portions 841 protrude at the end of the holding member 84 opposite to the photosensitive drum (the right side of FIGS. 9A and 9B). Therefore, when two movable pieces (not shown) press down the engagement portions 841 by a stress F larger than the urging force, the holding member 84 is rotatably moved clockwise on the sheet surface of FIGS. 9A and 9B. Thus, as the cleaning blade 81 is moved toward the side of the photosensitive drum and is inclined by an angle θ1 with respect to the vertical direction, as shown in FIG. 9A, that is, goes toward the side of the charging unit 3 (the right side of the drawing) from the virtual vertical plane VP, the cleaning blade 81 goes down and the front end portion of the cleaning blade 81 comes into contact with the bottom position BP of the photosensitive drum 1 in the state where the cleaning blade 81 is inclined only by an angle θ1.

In this embodiment, the cleaning blade 81 is shaft-supported about a pivot support shaft 87 as a pivot center with respect to the holding member 84 and is urged by a contact pressure adjusting spring member (not shown). Therefore, even when the pivot amount of the holding member 84 is slightly changed, a constant load, that is, a load determined by the urging force of the contact pressure adjusting spring member is configured to be applied to the bottom position surface of the photosensitive drum 1. The configuration in which the cleaning blade 81 comes into contact with the photosensitive drum 1 by the constant load is not limited to the above-described configuration, but other configurations according to the related art may be used.

When the cleaning blade 81 comes into contact with the photosensitive drum 1 (at the cleaning time), the developer receiving member 82 is parallel to the cleaning blade 81, as shown in FIGS. 9A and 9B. That is, the cleaning blade 81 is inclined only by an angle θ2 with respect to the vertical direction as the developer receiving member 82 moves from the virtual vertical plane VP to the side of the charging unit 3 (the right side of the drawing). However, the inclined angle θ2 is identical with the inclined angle θ1 of the cleaning blade 81. When the developer receiving member 82 is viewed from the virtual vertical plane VP and a width direction X (see FIG. 10), as shown in FIGS. 9A and 9B, an inclination lower end portion 821 extends up to the inside of the recovery member 83 and an inclined upper end portion 822 extends the left side of the virtual vertical plane VP on the sheet surface of FIG. 7 over the downward position of the bottom position BP of the photosensitive drum 1. Further, when the developer receiving member 82 is viewed from the inclination upper side, as shown in FIG. 10, the developer receiving member 82 is longer than the cleaning blade 81 on the downward side of the cleaning blade 81 in the vertical direction. That is, the length W81 of the cleaning blade 81 and the length W82 of the developer receiving member 82 in the width direction X have the following relationship:

W81<W82.

Therefore, when the liquid developer droops and drops from the bottom position BP of the photosensitive drum 1, the liquid developer is received by the developer receiving member 82, flows along the upper surface of the developer receiving member 82, that is, the inclined surface as a recovered liquid, and flows and drops to the inside of the recovery member 83.

As shown in FIG. 10, side fences (wall portions) 823 are erected upward in the vertical direction on both ends in the width direction X in the developer receiving member 82. Further, each side fence 823 extends toward the recovery member 83, and thus the recovered liquid (the liquid developer) received by the developer receiving member 82 is guided to the recovery member 83. Accordingly, the recovered liquid recovered by the developer receiving member 82 can reliably be recovered by the recovery member 83 without drooping the recovered liquid to the outside of the photosensitive cleaning section 8.

As shown in FIG. 10, the distance between both side fences 823 in the width direction X is narrower toward the recovery member 83. Therefore, the recovered liquid recovered by the developer receiving member 82 can efficiently be recovered without being diffused. Further, since the recovery path can be shortened in the width direction X, the recovery member 83 can become compact.

Even when the cleaning blade 81 is separated from the photosensitive drum 1 by pivoting the holding member 84 counterclockwise about the pivot center on the sheet surface of FIGS. 9A and 9B (at the non-cleaning time), the inclination upper end portion 822 of the developer receiving member 82 extends over the downward position of the bottom position BP of the photosensitive drum 1. Therefore, even when the liquid developer droops from the bottom position BP at the non-cleaning time, the liquid developer can reliably be received by the developer receiving member 82, and thus can reliably be received as the recovered liquid in the recovery member 83.

As described above, in the third embodiment, the so-called base transfer structure is used in which the blanket roller 21 is disposed on the downward side of the virtual horizontal plane HP, which passes through the rotation center of the photosensitive drum 1, in the vertical direction. Therefore, the toner image is transferred to the upper surface of the transfer sheet and the transfer sheet is transported in a state where the image surface faces upward. Accordingly, since the toner image can stably be formed, it is possible to obtain the advantage of transporting the transfer sheet without touch to the image surface. On the contrary, the liquid developer may fall down due to the own weight of the liquid developer on the surface of the photosensitive drum 1 and move to the bottom position BP of the photosensitive drum 1, and then the liquid developer may droop in some cases. However, since the developer receiving member 82 extends over the downward position of the bottom position BP of the photosensitive drum 1, the liquid developer dropping from the bottom position BP can reliably be recovered as the recovered liquid in the recovery member 83.

Since the cleaning blade 81 is configured to come into contact with the bottom position BP of the photosensitive drum 1 and clean the photosensitive drum 1, the flow direction of the liquid developer is regulated. Therefore, the liquid developer scraped by the cleaning blade 81 flows backward with respect to the rotation direction of the photosensitive drum 1 and falls downward in the vertical direction from the bottom position BP of the photosensitive drum 1 due to the own weight of the liquid developer. However, the liquid developer is recovered by the developer recovery mechanism (the developer receiving member 82 and the recovery member 83) of the photosensitive cleaning section 8. On the other hand, since the blanket roller 21 is disposed on the left side of the virtual vertical plane VP on the sheet surface of FIG. 7, the liquid developer drooping and falling down from the bottom position BP of the photosensitive drum 1 can reliably be prevented from being attached to the blanket roller 21, thereby preventing the image quality from deteriorating due to the drooping of the liquid developer.

In the third embodiment, the photosensitive drum 1 corresponds to the “image carrier drum” of the invention and the blanket roller 21 corresponds to the “transfer member” of the invention. The left and right sides of the virtual vertical plane VP on the sheet surface of FIG. 7 correspond to “the first side of the virtual vertical plane” and “the second side opposite to the first side of the virtual vertical plane” of the invention. The developer recovery mechanism including the developer receiving member 82 and the recovery member 83 corresponds to a “developer recovery unit” of the invention. The side fence 623 correspond to a “wall portion” of the invention. The ends of the developer receiving member 82 may be folded. Alternatively, fences members may be joined to the developer receiving member 82 by welding or may be integrally formed with the developer receiving member to form the side fences 823.

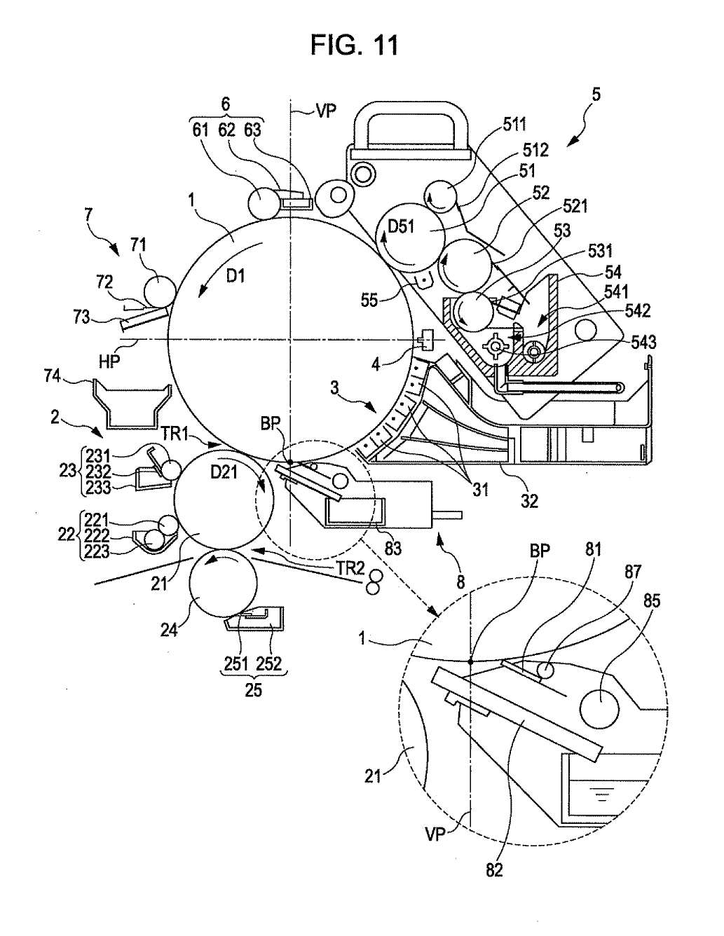

FIG. 11 is a diagram illustrating an image forming apparatus according to a fourth embodiment of the invention. The fourth embodiment is different from the third embodiment in the contact position of a photosensitive drum 1 and a cleaning blade 81. That is, in the fourth embodiment, the cleaning blade 81 comes into contact with the photosensitive drum 1 on the right side (the side of a charging unit) of a virtual vertical plane VP on the sheet surface of FIG. 11 and the contact position is on the downstream side of the bottom position BP in the rotation direction D1 of the photosensitive drum 1. Since the remaining configuration is basically the same as that of the third embodiment, the same reference numerals are given and the description thereof will not be repeated.

In the image forming apparatus with the above-described configuration, the flow direction of the liquid developer is regulated by the cleaning blade 81 on the downstream side of the bottom position BP. The liquid developer scraped by the cleaning blade 81 flows backward with respect to the rotation direction D1 of the photosensitive drum 1, is moved to the bottom position BP of the photosensitive drum 1, and falls downward in the vertical direction from the bottom position BP due to the own weight of the liquid developer. However, as in the third embodiment, the liquid developer is recovered by the developer recovery mechanism including the developer receiving member 82 and the recovery member 83.

Since the blanket roller 21 is disposed at the same position as that of the third embodiment and is disposed on the left side of the virtual vertical plane VP on the sheet surface of FIG. 11, the liquid developer drooping and falling down from the bottom position BP of the photosensitive drum 1 is not attached to the blanket roller 21, thereby preventing the image quality from deteriorating due to the drooping and attachment of the liquid developer.

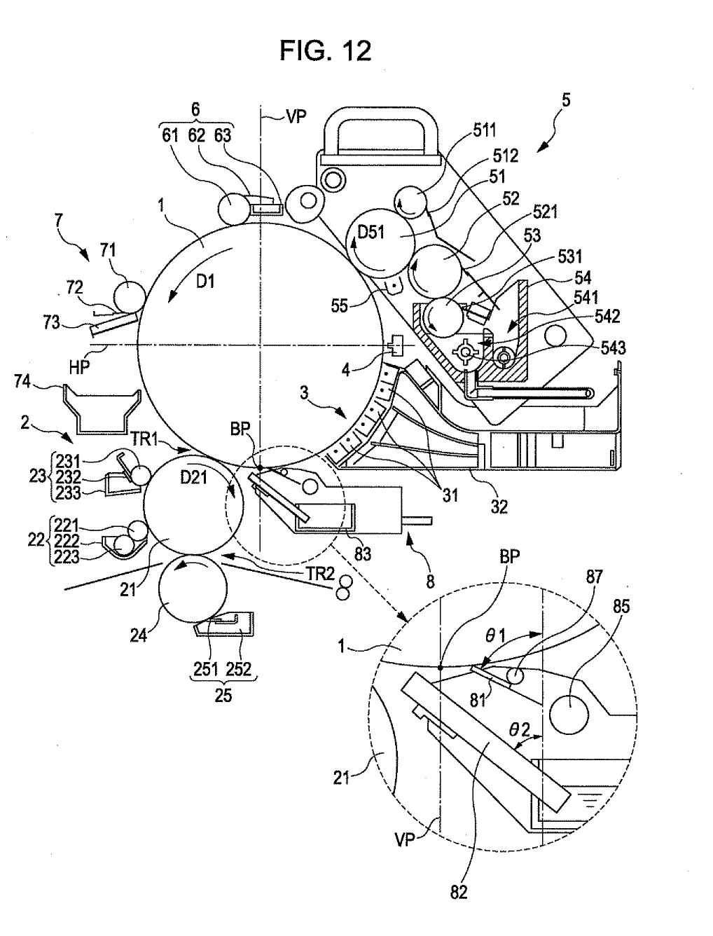

FIG. 12 is a diagram illustrating an image forming apparatus according to a fifth embodiment of the invention. In the fifth embodiment, in the image forming apparatus of the fourth embodiment, the developer receiving member 82 is mounted on the holding member 84 so that the inclination angle θ2 of the developer receiving member 82 is smaller than the inclination angle θ1 of the cleaning blade 81 in the state where the developer receiving member 82 comes into contact with the photosensitive drum 1. That is, the inclination of the developer receiving member 82 is steeper than that of the cleaning blade 81. Accordingly, compared to the fourth embodiment, the liquid developer received by the developer receiving member 82, that is, the recovered liquid is less likely to stay on the surface of the developer receiving member 82 and the recovered liquid can efficiently be recovered by the recovery member 83. Further, the developer receiving member 82 may be mounted on the holding member 84 so that the relationship of “θ1>θ2” is satisfied, and thus the same advantage can be obtained.

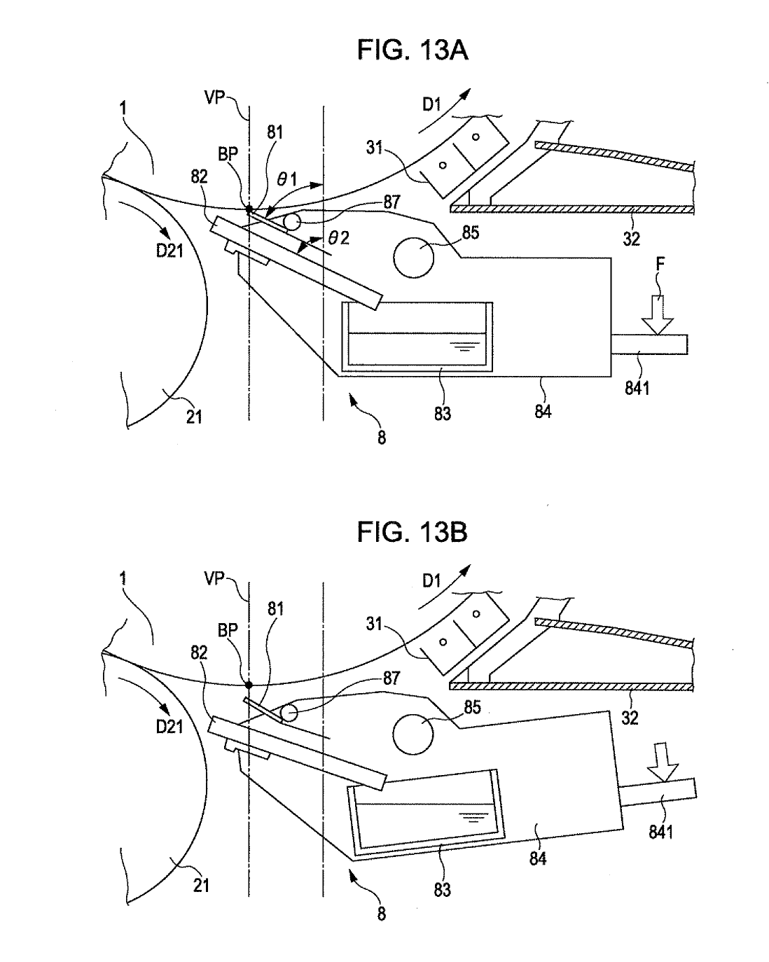

In the image forming apparatus according to this embodiment of the invention, both the recovery member 83 and the cleaning blade 81 are mounted on the holding member 84 and the recovery member 83 is pivoted about the pivot shaft 85 as the pivot center simultaneously with the operations of separating the cleaning blade 81 from the photosensitive drum 1 and bringing the cleaning blade 81 into contact with the photosensitive drum 1. Accordingly, when the pivot operation is performed, the recovered liquid (the liquid developer remaining in the photosensitive drum 1 and completely used) recovered by the recovery member 83 is shaken. Accordingly, as shown in FIGS. 13A and 13B, it is desirable to mount the recovery member 83 on the holding member 84 so that the recovery member 83 is located immediately below the pivot shaft 85. With such a configuration, it is possible to suppress the recovered liquid from coming out of the recovery member 83. FIG. 13A shows a state where the cleaning blade 81 comes into contact with the photosensitive drum 1 and FIG. 13B shows a state where the cleaning blade 81 is separated from the photosensitive drum 1.

The invention is not limited to the above-described embodiments, but may be modified in various forms other than the above-described embodiments without departing from the gist of the invention. For example, according to the above-described embodiments of the invention, the image forming apparatus forms a monochromatic toner image. However, the invention is applicable to an image forming apparatus in which toner images with a plurality of colors are transferred with the liquid developer on the lower side. That is, the invention is applicable to an image forming apparatus and an image forming method in which an image is formed with the liquid developer in the so-called base transfer structure.

In the above-described embodiments, the blanket roller 21 has been used as the “transfer member” of the invention. However, for example, an intermediate transfer member with a belt shape may be used.

The entire disclosure of Japanese Patent Application No. 2011-029499, filed Feb. 15, 2011 and No. 2011-057574, filed Mar. 16, 2011 are expressly incorporated by reference herein.

What is claimed is:

1. An image forming apparatus comprising:
an image carrier drum on which a latent image is formed;
a development unit which includes a development roller coming into contact with the image carrier drum on an upward side of a virtual horizontal plane, which is perpendicular to a virtual vertical plane passing through a rotation center of the image carrier drum, in a vertical direction and developing the latent image formed on the image carrier drum with a liquid developer containing toner and a carrier liquid;
a squeeze unit which comes into contact with the image developed by the development roller on the upward side of the virtual horizontal plane in the vertical direction and includes a squeeze roller squeezing the image; and
a transfer unit which transfers the image squeezed by the squeeze roller to a transfer member on a downward side of the virtual horizontal plane in the vertical direction.

2. The image forming apparatus according to claim 1, further comprising:
a charging unit which charges the image carrier drum;
an exposure unit which exposures the image carrier drum charged by the charging unit; and
a bias voltage generating unit which applies a bias voltage to the squeeze roller,
wherein the squeeze roller comes into contact with the image carrier drum on a side on which the image carrier drum and the development roller come into contact with each other with respect to the virtual vertical plane.

3. The image forming apparatus according to claim 1, wherein the squeeze unit includes a cleaning blade which comes into contact with the squeeze roller and cleans the squeeze roller and recovers the liquid developer.

4. The image forming apparatus according to claim 2,
wherein the charging unit is disposed on the side on which the image carrier drum and the development roller come into contact with each other with respect to the virtual vertical plane and on the downward side of the virtual horizontal plane in the vertical direction, and
wherein the transfer unit is disposed on a side opposite to the side on which the image carrier drum and the development roller come into contact with each other with respect to the virtual vertical plane.

5. The image forming apparatus according to claim 1, wherein the development unit includes
a storage section which is disposed on a downward side of the development roller in the vertical direction and stores the liquid developer,
a supply member which supplies the liquid developer stored in the storage section to the development roller,
a cleaning section which cleans the development roller and recovers the liquid developer, and
a recovery section which is disposed on a downward side of the cleaning section in the vertical direction and stores the liquid developer recovered by the cleaning section.

6. An image forming method comprising:
forming a latent image on an image carrier drum;
developing the latent image with a liquid developer containing a carrier liquid and toner carried on a development roller which is disposed on an upward side of a virtual horizontal plane, which is perpendicular to a virtual vertical plane passing through a rotation center of the image carrier drum, in a vertical direction;
bringing a squeeze roller disposed on the upward side of the virtual horizontal plane in the vertical direction into contact with the image developed by the development roller and squeezing the image; and
transferring the image squeezed by the squeeze roller to a transfer member on a downward side of the virtual horizontal plane in the vertical direction.

7. The image forming apparatus according to claim 1,
wherein the transfer member is disposed on a first side with respect to the virtual vertical plane and on the downward side of the virtual horizontal plane in the vertical direction,
wherein the image forming apparatus further comprises:
a cleaning blade which comes into contact with the image carrier drum to which the image is transferred at a position intersecting the virtual vertical plane on a downward side of the vertical direction of the image carrier drum or a second side opposite to the first side with respect to the virtual vertical plane and cleans the image carrier drum; and
a developer recovery unit which is disposed on the downward side of the position, which intersects the virtual vertical plane on the downward side of the image carrier drum in the vertical direction, in the vertical direction and stores the liquid developer recovered by the cleaning blade.

8. The image forming apparatus according to claim 7, wherein the developer recovery unit includes a developer receiving member which is disposed at a position extended to the first side from a position intersecting the virtual vertical plane on the downward side of the image carrier drum in the vertical direction from the downward side of the cleaning blade in the vertical direction and receives the dropping liquid developer, and a recover member which recovers the developer received by the developer receiving member.

9. The image forming apparatus according to claim 8, wherein, the developer receiving member is longer than the cleaning blade in a rotation shaft direction of the image carrier member on the downward side of the cleaning blade in the vertical direction.

10. The image forming apparatus according to claim 8, wherein the developer receiving member has wall portions at both ends in a rotation shaft direction of the image carrier drum.

11. The image forming apparatus according to claim 10, wherein the wall portions disposed at both ends in the rotation shaft direction of the image carrier drum guide the liquid developer received by the developer receiving member to the recovery member.

12. The image forming apparatus according to claim 11, wherein a distance between the wall portions disposed at both ends in the rotation shaft direction of the image carrier drum is narrower toward the recovery member.

13. The image forming apparatus according to claim 8,
wherein the cleaning blade is rotated about a rotation center to come into contact with and be separated from the image carrier drum,
wherein the developer recovery unit is rotated about the rotation center together with the cleaning blade, and
wherein the recovery member is disposed in a downward side of the rotation center in the vertical direction.

14. The image forming method according to claim 6, further comprising:
transferring the image developed with the liquid developer and carried on the image carrier drum to the transfer member disposed on a first side with respect to the virtual vertical plane and the downward side of the virtual horizontal plane in the vertical direction;
bringing a cleaning blade into contact with the image carrier drum to which the image is transferred at a position intersecting the virtual vertical plane on a downward side of the image carrier drum in the vertical direction or a second side opposite to the first side with respect to the virtual vertical plane and cleaning the image carrier drum; and
recovering the liquid developer dropping from the image carrier drum by a developer recovery unit which is disposed on the downward side of the position, which intersects the virtual vertical plane on the downward side of the image carrier drum in the vertical direction, in the vertical direction.
